(19) United States
(12) Patent Application Publication
(10) Pub. No.: US 2010/0026233 A1
(43) Pub. Date: Feb. 4, 2010

(54) SENSOR-CONTROLLED FLUSHING DEVICE AND METHOD AND SYSTEM FOR MANAGING POWER THEREOF

(76) Inventors: Chi-Ching Lee, Taoyuan Hsien (TW); Chih-Yuan Chang, Taoyuan Hsien (TW)

Correspondence Address: Muncy, Geissler, Olds & Lowe, PLLC, P.O. BOX 1364, FAIRFAX, VA, 22038-1364, US

(21) Appl. No.: 12/240,808

(22) Filed: Sep. 29, 2008

(30) Foreign Application Priority Data
Jul. 29, 2008 (TW) 097128644

(51) Int. Cl. H02J 7/00

(52) U.S. Cl. 320/101

(57) ABSTRACT

A power managing system includes a battery, a solar cell, a detecting circuit and a control module. The solar cell transforms a received light into a voltage and the battery is charged by the solar cell. The detecting circuit detects the voltage and correspondingly generates a detecting signal. The control module controls a pathway between the battery and the solar cell according to the detecting signal.

### CROSS REFERENCE TO RELATED APPLICATIONS

This Non-provisional application claims priority under 35 U.S.C. §119(a) on Patent Application No(s). 097128644 filed in Taiwan, Republic of China on Jul. 29, 2008, the entire contents of which are hereby incorporated by reference.

### BACKGROUND OF THE INVENTION

1. Field of Invention

The present invention relates to a sensor-controlled flushing device and method and system for managing power thereof and, in particular, to a power managing system applying energy generated by solar cell efficiently.

2. Related Art

In general, conventional sensor-controlled flushing device applied to a urinal or a tap is developed according to electric standard specification. The electronic control components of conventional device are powered by DC power supply so that AC power needs to be transformed into DC power. Accordingly, a transformer is necessary for transforming voltage, resulting in a high cost and a large sized conventional device. The transformer also causes mass consumption of heat energy and magnetic energy when transforming. Further, if the solenoid valve of the AC power product is a non-maintainable solenoid valve, power consumption of long-time activation of the solenoid valve is huge. Otherwise, the conventional device is more complicated and difficult in assembly, and the reserved electric cord in a building is necessary for setting up the conventional device so that the conventional device is unpopular.

Another type of conventional sensor-controlled flushing device is powered by DC power. It is a battery-powered product, but the product lifetime is limited due to battery capacity. Accordingly, it is necessary to change new battery periodically for continuing its function, thereby generating more exhaust batteries so as to pollute the enviromnent. Even if the battery is replaced with a rechargeable battery, the product still has the disadvantages like that of the conventional device powered by AC power. Meanwhile, a battery charger is in need, and the assembly is more complicated and difficult. The reserved electric cord in the building is also necessary.

### SUMMARY OF THE INVENTION

In view of the foregoing, the invention is to provide a sensor-controlled flushing device and method and system for managing power thereof and, in particular, to a power managing system applying energy generated by solar cell efficiently.

To achieve the above, a power managing system of the present invention includes a battery, a solar cell, a detecting circuit and a control module. The solar cell transforms a received light into a voltage and the battery is charged by the solar cell. The detecting circuit detects the voltage and correspondingly generates a detecting signal. The control module controls a pathway between the battery and the solar cell according to the detecting signal.

The control module is preset a first default voltage and a second default voltage, and the first default voltage is higher than the second default voltage. When the voltage is higher than the first default voltage, the control module activates the pathway between the solar cell and the battery so that the battery is charged by the solar cell. When the voltage is lower than the first default voltage and higher than the second default voltage, the control module deactivates the pathway between the solar cell and the battery so that the control module is powered by the solar cell directly.

There is a first switching element disposed between the battery and the solar cell, and the control module controls the pathway between the battery and the solar cell through the first switching element. There is a second switching element disposed between the detecting circuit and the solar cell, and the detecting circuit periodically detects the voltage through the periodical activation of the second switching element controlled by the control module.

The power managing further includes a diode and a capacitor disposed between the solar cell and the battery. The diode is applied to prevent from a reverse current from the battery to the solar cell. The capacitor is applied to prestore electric charge generated by the solar cell. The control module is preferably a logic circuit, a micro control unit (MCU) or an integrated circuit. The power managing system is preferably applied to a solenoid valve device or a sensor-controlled flushing device.

To achieve the above, a power managing method of the present invention includes the steps of: providing a solar cell and a battery, transforming a received light into a voltage through the solar cell, detecting the voltage, and deactivating the pathway between the battery and the solar cell when the voltage being lower than a first default voltage. Where when the voltage is higher than the first default voltage or lower than a second default voltage, reactivates the pathway between the battery and the solar cell. The second default voltage is lower than the first default voltage.

To achieve the above, a sensor-controlled flushing device of present invention includes a battery, a solenoid valve, a solar cell, a detecting circuit, a sensor and a control module. The battery is charged by the solar cell. The solenoid valve is powered by the battery. The solar cell transforms a received light into a voltage. The detecting circuit detects the voltage and generates a detecting signal. The sensor senses an ambient parameter. The control module controls a pathway between the battery and the solar cell according to the detecting signal and an activation of the solenoid valve according to the ambient parameter.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a block diagram of a power managing system according to an embodiment of the present invention;

FIG. 2 is a block diagram of a sensor-controlled flushing device according to an embodiment of the present invention; and

FIG. 3 is a flow chart of a power managing method according to an embodiment of the present invention.

### DETAILED DESCRIPTION OF THE INVENTION

The present invention will be apparent from the following detailed description, which proceeds with reference to the accompanying drawings, wherein the same references relate to the same elements.

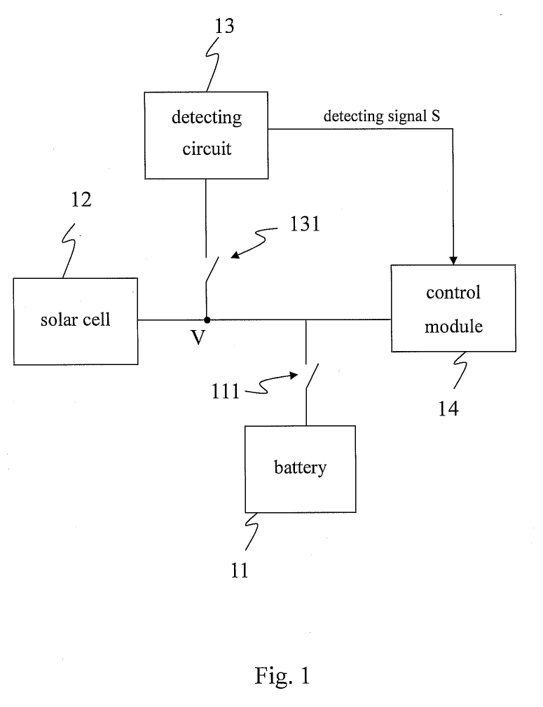

Referring to FIG. 1, a power managing system applied to a sensor-controlled flushing device according to an embodiment of the present invention includes a battery 11, a solar cell 12, a detecting circuit 13 and a control module 14. The solar cell 12 transforms a received light into a voltage V and the battery 11 is charged by the solar cell 12. The detecting circuit 13 detects the voltage V and correspondingly generates a detecting signal S. The control module 14 controls a pathway between the battery 11 and the solar cell 12 according to the detecting signal S.

A first default voltage and a second default voltage are preset in the control module 14, and the first default voltage is higher than the second default voltage. When the voltage V is higher than the first default voltage, the control module 14 activates the pathway between the solar cell 12 and the battery 11 so that the battery 11 is charged by the solar cell 12. When the voltage V is lower than the first default voltage and higher than the second default voltage, the control module 14 deactivates the pathway between the solar cell 12 and the battery 11 so that the control module 14 is powered by the solar cell 12 directly.

The power managing system further includes a first switching element 111 disposed between the battery 11 and the solar cell 12, and the control module 14 controls the pathway between the battery 11 and the solar cell 12 through the first switching element 111. The power managing system further includes a second switching element 131 disposed between the detecting circuit 13 and the solar cell 12, and the detecting circuit 13 periodically detects the voltage V through the periodical activation of the second switching element 131 controlled by the control module 14.

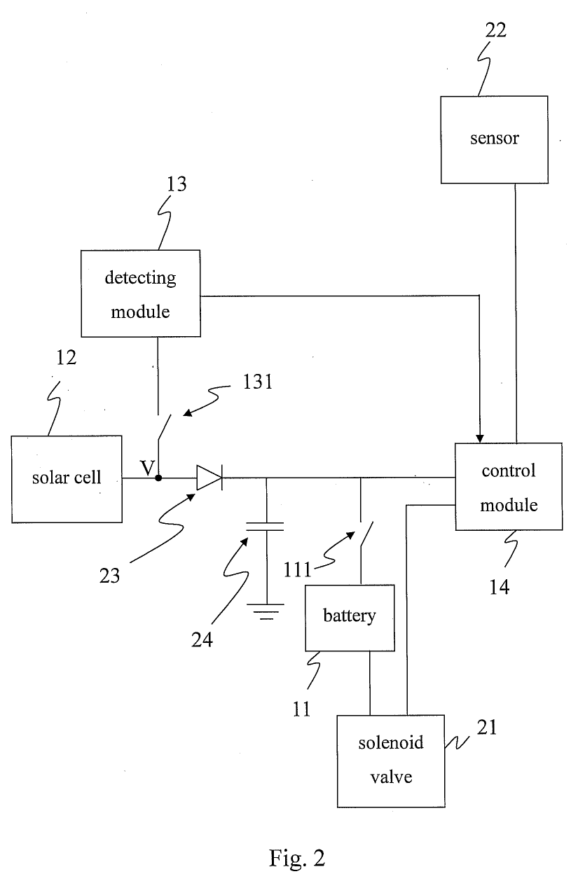

Referring to FIG. 2, a sensor-controlled flushing device according to an embodiment of the present invention includes a diode 23 disposed between the solar cell 12 and the battery 11, and a capacitor 24 disposed between the diode 23 and the battery 11. The diode 23 can prevent a reverse current from the battery 11 to the solar cell 12. The capacitor 24 prestores electric charge generated by the solar cell 12. The sensor-controlled flushing device further includes a sensor 22 to detect whether a user exist around the sensor-controlled flushing device or not and generate an ambient parameter. Then, the ambient parameter is transmitted to the control module 14. The control module 14 controls an activation of the solenoid valve 21 according to the ambient parameter. For example, the control module 14 activates the solenoid valve 21 when a user exists around the sensor, and the control module 14 deactivates the solenoid valve 21 when a user does not exist around the sensor. The solenoid valve 21 is powered by the battery 11. The sensor is preferably an infrared ray sensor. The control module 14 is preferably a logic circuit, a micro controller or an integrated circuit.

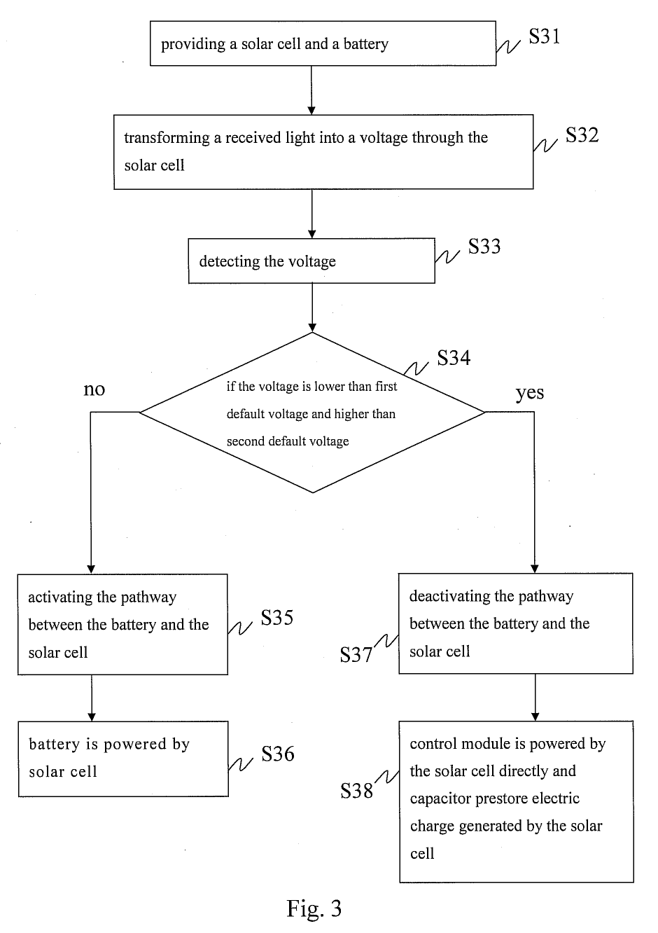

With reference to FIG. 3, a power managing method according to an embodiment of the present invention includes the steps S31 to S38 as follow:

In step S31, a solar cell and a battery are provided.

In step S32, a received light is transformed into a voltage through the solar cell to charge the battery.

In step S33, the voltage is detected.

In step S34, it is judged whether the voltage is lower than a first default voltage and higher than a second default voltage or not, and steps S35 or S37 is performed according to the judged result of the step S34.

In step S35, a pathway between the battery and the solar cell is activated if the voltage is not lower than the first default voltage and higher than the second default voltage.

In step S36, the battery is charged by the solar cell.

In step S37, the pathway between the battery and the solar cell is deactivated if the voltage is lower than the first default voltage and higher than the second default voltage.

In step S38, the control module is powered by the solar cell directly, and electric charge generated by the solar cell is prestored in a capacitor.

In summary, a sensor-controlled flushing device and power managing system thereof adopt two power supplies of the solar cell and the rechargeable battery. Two power supplies are coordinately provided for the control module and solenoid valve. The rechargeable battery and back-end load can be powered by the solar cell as long as the solar cell is disposed at a bright place. The load can be powered by the rechargeable battery continuously and steadily.

Otherwise, the detecting circuit of the present invention detects the voltage generated by the solar cell. When the voltage generated by the solar cell is lower than the voltage of the rechargeable battery, the rechargeable battery can not be charged effectively so as to waste energy. Accordingly, the pathway between the solar cell and the battery can be deactivated so that the energy transformed by the solar cell can be stored in the capacitor. The control module is powered by the solar cell instead of the battery. The electric current of the battery is only provided for the solenoid valve. When the voltage generated by the solar cell continuously decreases so much that the control module can not be powered enough, the pathway between the solar cell and the battery is reactivated, and the control module is powered by the battery. Thus, the energy generated by the solar cell can be utilized efficiently.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A power managing system comprising:
a battery;
a solar cell transforming a received light into a voltage;
a detecting circuit detecting the voltage and correspondingly generating a detecting signal; and
a control module controlling a pathway between the battery and the solar cell according to the detecting signal.

2. The power managing system according to claim 1, further comprising a first switching element disposed between the battery and the solar cell, wherein the control module controlls the pathway between the battery and the solar cell through the first switching element.

3. The power managing system according to claim 1, wherein when the voltage is higher than a first default voltage, the control module activates the pathway between the solar cell and the battery so that the battery is charged by the solar cell, and when the voltage is lower than the first default voltage, the control module deactivates the pathway between the solar cell and the battery.

4. The power managing system according to claim 3, wherein when the voltage is lower than a second default voltage, the control module reactivates the pathway between the solar cell and the battery, and the second default voltage is lower than the first default voltage.

5. The power managing system according to claim 1, further comprising a diode disposed between the solar cell and the battery to prevent a reverse current from the battery to the solar cell.

6. The power managing system according to claim 1, further comprising a capacitor disposed between the solar cell and the battery for prestoring electric charge generated by the solar cell.

7. The power managing system according to claim 1, further comprising a second switching element disposed between the detecting circuit and the solar cell, wherein the detecting circuit periodically detects the voltage through the periodical activation of the second switching element controlled by the control module.

8. The power managing system according to claim 1, wherein the power managing system is applied to a solenoid valve device or a sensor-controlled flushing device.

9. The power managing system according to claim 1, wherein the control module is a logic circuit, a micro controller or an integrated circuit.

10. A power managing method comprising steps of:
providing a solar cell and a battery;
transforming a received light into a voltage through the solar cell;
detecting the voltage; and
deactivating the pathway between the battery and the solar cell when the voltage being lower than a first default voltage.

11. The power managing method according to claim 10, wherein when the voltage is higher than the first default voltage or lower than a second default voltage, the pathway between the battery and the solar cell is reactivated; when the voltage is smaller than the second default voltage, the pathway between the battery and the solar cell is activated, wherein the second default voltage is lower than the first default voltage.

12. A sensor-controlled flushing device comprising:
a battery;
a solenoid valve powered by the battery;
a solar cell transforming a received light into a voltage;
a detecting circuit detecting the voltage and generating a detecting signal;
a sensor detecting an ambient parameter; and
a control module controlling a pathway between the battery and the solar cell according to the detecting signal and an activation of the solenoid valve according to the ambient parameter.

13. The sensor-controlled flushing device according to claim 12, further comprising a first switching element disposed between the battery and the solar cell, wherein the control module controlls the pathway between the battery and the solar cell through the first switching element.

14. The sensor-controlled flushing device according to claim 12, wherein when the voltage is higher a first default voltage, the control module activates the pathway between the solar cell and the battery so that the battery is charged by the solar cell, and when the voltage is lower than the first default voltage, the control module deactivates the pathway between the solar cell and the battery.

15. The sensor-controlled flushing device according to claim 14, wherein when the voltage is lower than a second default voltage, the control module reactivates the pathway between the solar cell and the battery, and the second default voltage is lower than the first default voltage.

16. The sensor-controlled flushing device according to claim 12, further comprising a diode disposed between the solar cell and the battery to prevent a reverse current from the battery to the solar cell.

17. The sensor-controlled flushing device according to claim 12, further comprising a capacitor disposed between the solar cell and the battery for prestoring electric charge generated by the solar cell.

18. The sensor-controlled flushing device according to claim 12, further comprising a second switching element disposed between the detecting circuit and the solar cell, wherein the detecting circuit periodically detects the voltage through the periodical activation of the second switching element controlled by the control module.

19. The sensor-controlled flushing device according to claim 12, wherein the control module is a logic circuit, a micro controller or an integrated circuit, and the sensor is an infrared ray sensor.

20. The sensor-controlled flushing device according to claim 12, wherein the sensor detects whether a user exists around the sensor-controlled flushing device or not and generates the ambient parameter.
